(19) United States
(12) Patent Application Publication
(10) Pub. No.: US 2026/0061524 A1
(43) Pub. Date: Mar. 5, 2026

(54) HOLD-DOWN TOOL AND LASER WELDING SYSTEM EQUIPPED THEREWITH

(71) Applicant: Hesse GmbH, Paderborn (DE)

(72) Inventors: Sascha BISTRY, Paderborn (DE); Hans-Juergen HESSE, Paderborn (DE); Alexander KLINGEBIEL, Bielefeld (DE); Patrick VEHMEIER, Luegde-Hummersen (DE); Frank WALTHER, Paderborn (DE)

(73) Assignee: Hesse GmbH, Paderborn (DE)

(21) Appl. No.: 19/380,561

(22) Filed: Nov. 5, 2025

Related U.S. Application Data
(63) Continuation of application No. PCT/DE2024/100248, filed on Mar. 22, 2024.

(30) Foreign Application Priority Data
May 5, 2023 (DE) 10 2023 111 842.0

(51) Int. Cl. B23K 26/70; B23K 26/06; B23K 26/21; B23K 37/04

(52) U.S. Cl. CPC B23K 26/702; B23K 26/0665; B23K 26/21; B23K 37/04

(57) ABSTRACT

A hold-down tool for a laser welding system, comprising a tubular hollow body which has a lateral surface that is designed to be closed in a laminar manner at least in some sections. At least one contact element is designed to be flexible and/or is held in a flexible manner and provides a tool contact surface for bringing the contact element into contact with a contact component to be welded. A laser welding system comprising a laser source, which comprises an optical unit for shaping a laser beam provided by the laser source and for providing a focused laser beam, and comprises the hold-down tool. The focused laser beam being guided through the hollow body of the hold-down tool.

This nonprovisional application is a continuation of International Application No. PCT/DE2024/100248, which was filed on Mar. 22, 2024, and which claims priority to German Patent Application No. 10 2023 111 842.0, which was filed in Germany on May 5, 2023, and which are both herein incorporated by reference.

### BACKGROUND OF THE INVENTION

### Field of the Invention

The invention relates to a hold-down tool for a laser welding system. Furthermore, the invention relates to a laser welding system comprising the hold-down device.

### Description of the Background Art

Classic laser welding systems have been used for many years to bond metallic contact components in particular. Today, these laser welding systems are only able to compensate for the shape and position tolerances of the contact components to a very limited extent.

### SUMMARY OF THE INVENTION

It is therefore an object of the present invention to provide an improved hold-down tool for a laser welding system and a laser welding system with such an improved hold-down tool.

To achieve the object, in an example, the invention has a hold-down tool for a laser welding system comprises a tubular hollow body which has a lateral surface that is designed to be closed in a laminar manner at least in some sections, and at least one contact element, which is designed to be flexible and/or is held in a flexible manner and provides a tool contact surface for bringing the contact element into contact with a contact component to be welded. In particular, it may be provided that the at least one contact element is held flexibly to the hollow body of the hold-down tool.

An advantage of the invention is that the hold-down tool with the flexibly designed or held contact element can compensate for the shape and position tolerances of the contact components to be welded. This makes it possible to counteract non-flat positioning of the contact components and contamination of the area surrounding the weld connection.

At least three and preferably at least five and particularly preferably seven or more contact elements can be provided. For example, the contact elements can be spaced from each other in a circumferential direction of the hollow body and preferably arranged evenly distributed. Advantageously, the majority of the contact elements ensure that force is applied evenly from the hold-down tool to the contact components. This counteracts locally impermissible high loads and the resulting damage to the contact components. In addition, the distributed arrangement of the system elements ensures that any shape or position tolerances are compensated over a large area in the entire weld. This promotes the flat contact of the contact components with each other and contributes to good welding.

The contact element can be realized as part of the hollow body. The one-piece design of the contact element and hollow body reduces assembly times. This results in production-related advantages.

The tool contact surface can be provided by the end face of the hollow body. This is preferable if the hollow body and the contact element are formed in one piece.

The at least one contact element can be attached to the hollow body on the outer shell side. The attachment of the outer shell side of the contact element to the hollow body allows for easy functional testing or checking of proper assembly, for example by means of an inspection. In addition, assembly is simplified by the outer shell side attachment of the contact element and its easy accessibility.

The at least one contact element can be spring-mounted. For example, the spring-mounting of the contact element can be achieved by means of a pressure spring. It has been shown to be advantageous that spring-mounting the contact element on the hollow body can be implemented both cost-effectively and robustly. In this respect, corresponding hold-down tools are durable and at the same time characterized by a high level of cost-effectiveness.

The tool contact surface can be convex. The convex shape of the tool contact surface, i.e., curved outward, defines a variable contact area in which the contact of the hold-down tool with the contact components is formed even if the contact components and the hold-down tool are not ideally perpendicular.

The tool contact surface can be designed to be annular and/or flat. The particular advantage of the ring-shaped or flat tool contact surface is that the hold-down tool can be placed flush on a flat surface of the contact component facing it. This results in a flat application of force and/or effective shielding of the weld. Contamination in the area surrounding the weld is thus effectively prevented.

The hollow body provides slit-like recesses to achieve flexibility of the at least one contact element. The slit-like recesses can be meandering and/or helix-shaped, for example. By providing the slit-like recesses, the hollow body is made flexible, which can be adjusted or influenced within wide limits to suit requirements by means of the size, number, and position of the recesses. The slit-like recesses make it possible to design an area of the hollow body, in particular an end area of the hollow body, as a contact element. The slit-like recesses can be tilted in a radial direction and/or shielded on the inside to prevent metal spatters from passing through the recesses and polluting the surrounding area or adhering to the recesses and solidifying in such a way that their flexible function is affected.

The at least one contact element can be designed as a contact pin and/or as a contact ring. Advantageously, by providing a pin-shaped contact element, and preferably by providing three or more similar pin-shaped contact elements, the hold-down device can be gently placed on a first contact component extending not perpendicular to a longitudinal center axis or axis of symmetry of the hold-down tool, pressing the first contact component flat against a second contact component located underneath. This is precisely what can also be achieved with a ring-shaped contact element, provided that the contact element can be pivoted relative to the hollow body. The ring-shaped contact element also improves the shielding of the weld and counteracts contamination of the surrounding area.

The at least one contact element can be formed as a hollow ball ring segment or hollow ball ring segment-like element. The hollow body may then be provided with a support surface, in particular a ball-bearing-like surface, shaped to correspond to a ball ring segment-like contour of the contact element against which the contact element can be placed flat. The flexible or spring-loaded attachment of the contact element to the hollow body is also achieved by the tool insert being arranged so it can pivot relative to the hollow body. In this respect, even when the contact element is inclined relative to the hollow body, it is possible to achieve flat force transmission from the hollow body to the contact element and on to the contact components. This provides stability for tolerance compensation and counteracts local, impermissibly high loads and thus damage to the hold-down tool and/or the contact components.

The hollow body can have an axis of symmetry. The flexibility of the at least one contact element acts, for example, in a direction of the axis of symmetry. In particular, the longitudinal center axis of the hold-down tool can form the axis of symmetry.

The hold-down tool, the contact element and/or the hollow body can be made of an electrically insulating material and preferably of technical ceramics, at least in an area comprising the tool contact surface. The technical ceramics offer high resistance and mechanical strength. At the same time, they are thermally very resilient and therefore particularly suitable as a material for the contact element positioned in close proximity to the weld.

Also, to achieve the object, the invention comprises a laser welding system comprises a laser source, an optical unit for forming a laser beam provided by the laser source and for providing a focused laser beam, and a hold-down tool according to the invention. The focused laser beam is guided through the hollow body of the hold-down tool.

The hold-down tool as well as the optical unit and/or the laser source can be arranged so as to be movable in a vertical direction (Z-direction). In addition, a movable bracket can be provided in the plane perpendicular to the symmetry or longitudinal center axis of the tool, i.e., in the XY plane. For example, portal kinematics can be used to move the hold-down tool, optical unit and/or laser source and position them as needed.

Further advantages, features and details of the invention can be found in the further subclaims and the following description. In any case, the features mentioned there can be material to the invention individually or in any combination. The features and details of the hold-down tool described according to the invention naturally also apply in connection with the laser welding system, and vice versa. Thus, the disclosure can always be referred to reciprocally in respect of the individual aspects of the invention. The drawings serve only as examples to clarify the invention and have no restrictive character.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic diagram of a laser welding system comprising a hold-down tool, with an ideally perpendicular orientation of a working plane to a symmetry axis plane of the hold-down tool and extension of the contact components to be welded in the working plane,

FIG. 2 is a view of a gap of non-constant width between hold-down tool and contact components with a non-parallel orientation of the contact components to the working plane,

FIG. 3 is a perspective view of an example of the hold-down tool,

FIG. 4 is a perspective view of an example of the hold-down tool,

FIG. 5 is a perspective view of an example of the hold-down tool,

FIG. 6 is a perspective view of an example of the hold-down tool,

FIG. 7 is a perspective view of an example of the hold-down tool,

FIG. 8 is a perspective view of an example of the hold-down tool,

FIG. 9 is a longitudinal cut through the hold-down tool in the example,

FIG. 10 is a perspective view of the example of the hold-down tool according to FIG. 9,

FIG. 11 is a perspective view of an example of the hold-down tool,

FIG. 12 is a perspective view of an example of the hold-down tool,

FIG. 13 is a longitudinal cut through the example of the hold-down tool according to FIG. 12, and

FIG. 14 is a perspective view of an example of the hold-down tool

### DETAILED DESCRIPTION

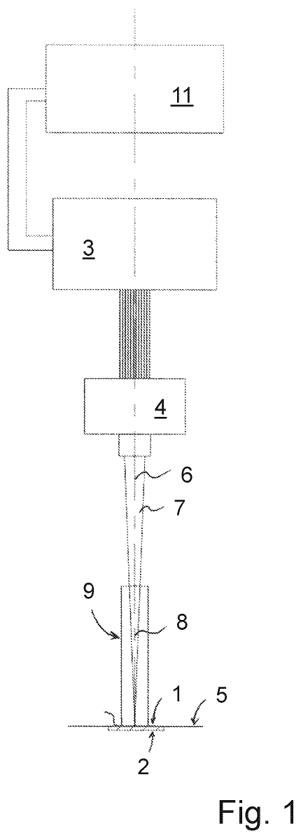

For the welding of metallic contact components 1, 2 in electrical engineering, battery technology and power electronics, laser welding systems with a laser source 3 as an energy source are used, among other things. A laser beam provided by the laser source 3 is typically guided through an optical fiber to an optical unit 4, which is located above the contact components 1, 2 and a working plane 5. The optical unit 4 is aligned in such a way that the symmetry axis 6 of the focused beam 7 runs collinear with a longitudinal center axis or symmetry axis 8 of a hold-down tool 9 of the laser welding machine and perpendicular to the working plane 5 (compare FIG. 1).

The contact components 1, 2 to be welded or their contact surfaces are extended in the working plane 5 or parallel to it. The contact surfaces of the contact components 1, 2 run parallel to each other. The hold-down tool 9 is then used to press the contact components 1, 2 against each other without gaps. In particular, in the case of the preferred deep-welding, the contact components 1, 2 to be welded must lie flush on top of each other. There must be no gap between the contact components 1, 2, otherwise high-quality, low-spatter or spatter-free welding is not possible.

The contact points of the contact components 1, 2 to be connected can, if the topology allows it, be aligned such that they are directly connected to each other. No additional wires (with round or rectangular cross-sections) are then necessary to create an electrically conductive connection.

If there are a large number of contact points or if they are unfavorably located, a direct connection of the contact points is not possible, additional conductors are required, which must be brought to the contact points and connected there to the contact points of the components by a suitable connection technology. In order not to have to bring the conductors individually to the respective contact points, it makes sense to combine the necessary connections in an additional contacting system. The contacting system typically resembles a printed circuit board, which contains all the wires for connecting the individual components. Such contacting systems are used, for example, for the wiring of larger battery modules or other matrix-arranged components. At the points where the contact points of the module to be wired are located, the contacting system has clearances from which a contact strip emerges and can be connected to the contact of the module.

For example, the hold-down tool 9 used to establish the contacts is tubular. It is flatly attached with an end face 10 facing away from the optical unit 4 to a first, upper contact component 1 facing the optical unit 4 and is dimensioned or positioned in such a way that the focused laser beam 7 is guided through it and strikes the first contact component 10 at the end face 10 facing away from the optical unit 4. The flat attachment of the hold-down tool 9 ensures that melted material during welding does not spatter uncontrollably. In this respect, the hold-down tool 9 prevents contamination of the surrounding area and possible malfunction due to the formation of damaged, unintentional electrically conductive contacts.

The modules can contain contact points or contact surfaces of different heights. The hold-down tool 9 is firmly connected to an axis system of the laser welding system, which is movable in the vertical direction. In this respect, the hold-down tool 9 can reach contact points or contact surfaces at different heights. The orientation of the hold-down tool 9 is perpendicular to the working plane 5 on which the modules are fixed. Furthermore, it can be provided that the hold-down tool 9 is moved and positioned horizontally by means of suitable xy kinematics.

The optical unit 4 of the laser welding system shown in FIG. 1 can be controlled by a controller 11 of the laser welding system and is set up to move the focused laser beam 7 along the contact components 1, 2 and to form a linear or flat weld.

In practice, it is often observed that the contact elements 1, 2 are not arranged exactly in the working plane 5 and/or do not extend parallel to each other. For example, due to their shape, the contact elements 1, 2 may only touch each other at a few points and/or be arranged at an angle to working plane 5 and/or to each other. In this case, it is not possible to place the contact components 1, 2 flat against each other and to place the hold-down tool 9 flat against the first, upper contact components without difficulty.

Relative to the working plane of the system, the contact surfaces of the modules that form the second, lower contact component 2 can be slanted. In such cases, the contacts to be connected must be aligned parallel to the contact surface of the module to ensure a zero gap and to ensure permanent and conductive contact. This is not possible with a fixed hold-down tool that is aligned perpendicular to the working plane.

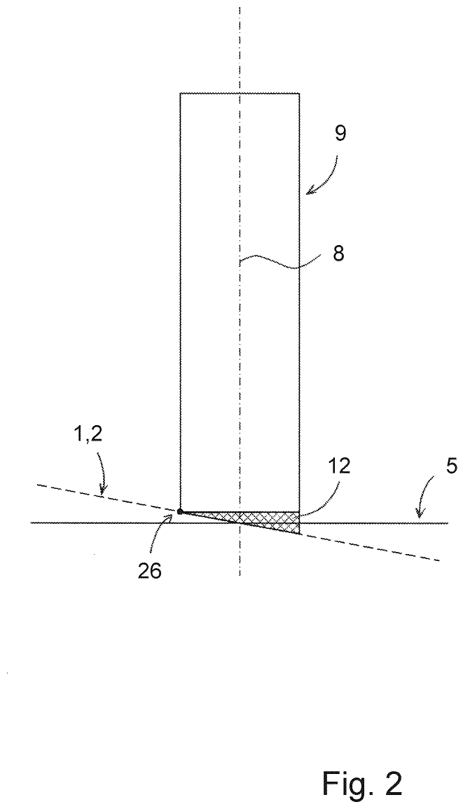

FIG. 2 illustrates the facts of the case as an example in the case that the contact components 1, 2 are arranged at an angle to the working plane 5. The hold-down tool 9 touches the first, upper contact component 1 only at a single point of contact 26 and consequently a gap 12 is formed through which molten material can pass.

In order to counteract the formation of the gap 12 in the event of an unfavorable alignment of the contact components 1, 2 to each other and/or to the working plane 5, and to promote a flat attachment of contact components 1, 2 to each other, the hold-down tool 9 can adapt to the position and shape of the contact components 1, 2, especially in the area of the end face 10 facing away from the optical unit 4. Here, it is possible to compensate for misalignment in the single-digit range (0° to <10°).

To adapt to the position and shape of the contact components 1, 2, the pivot point for the alignment of the hold-down tool 9 should be in the contact plane if possible in order to prevent the first contact component 1 from sliding on the contact surface. Viewed from the direction of the laser source 3, the inner contour of the hold-down tool 9 should preferably not be changed. Cardanic mounting with the pivot points above the contact surface are disadvantageous, as the contour of the hold-down tool is not retained in the longitudinal direction for such systems. However, the double cardan joint can still be used for small deflections due to negligible disadvantages.

The hold-down tool 9 can have an arbitrarily shaped cross-section, which can be realized as a circle, ellipse, polygon or by arbitrarily shaped other closed trajectories. The volume limited by the inner contour is removed from the hold-down tool 9; the inner contour limits the cavity. The inner contour may be different from the outer contour to incorporate additional functionality into the hold-down tool 9. The cross-sectional surfaces of the hold-down tool 9 (inside and outside) can change in the longitudinal direction of the tool 9. The base surfaces of the hold-down tool can be inclined against each other or run parallel.

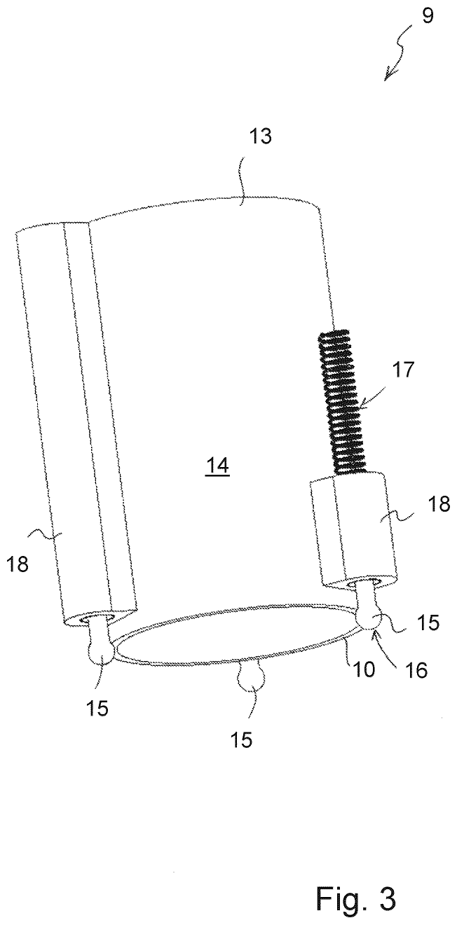

A first embodiment of a hold-down tool 9 according to FIG. 3 provides an exemplary cylindrical hollow body 13 with a closed lateral surface 14. On the outer shell side, a total of three contact elements 15 are arranged on the hollow body 13 in the circumferential direction. The contact elements 15 are pin-shaped and provide a ball head that provides a convex curved tool contact surface 16. The tool contact surfaces 16 of the three contact elements 15 can be used to press the first, upper contact component 1 against the second, further contact component 2. This is possible even if the second contact component 2 is oriented at an angle to the working plane 5 and is designed to be so rigid that it does not deform when the hold-down tool 9 is lowered.

The contact pins 15 are held and guided elastically or flexibly in a guide 18 by means of a spring 17. As an example, one of the two guides 18 shown is only partially shown to illustrate the structure.

The closed lateral surface 14 of the hollow body 13 shields the focused laser beam 7 including any reflections. It also serves as a splash guard.

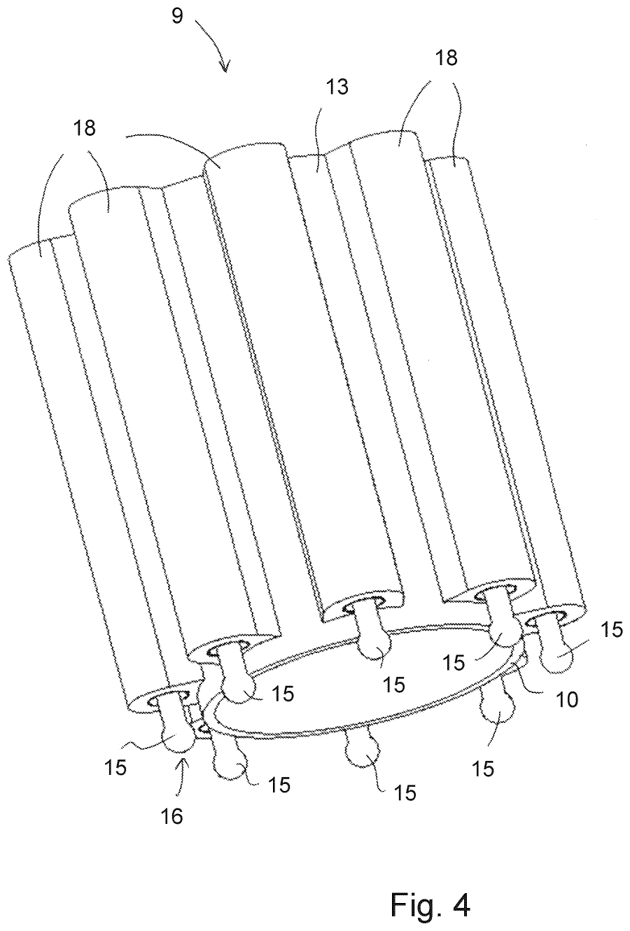

FIG. 4 shows a second embodiment of the hold-down tool 9. The basic design and functionality of this hold-down tool 9 is very similar to the first embodiment. However, eight contact pins 15 are now held in place by springs and are arranged in a circumferential direction.

The hold-down tool 9 according to the first embodiment is particularly suitable for flat contact components 1,2 whose extension in a plane is clearly determined by three points. The hold-down tool 9 with the eight contact pins 15, on the other hand, is particularly suitable for configurations in which the first and/or second contact components 1, 2 are wavy or otherwise not flat.

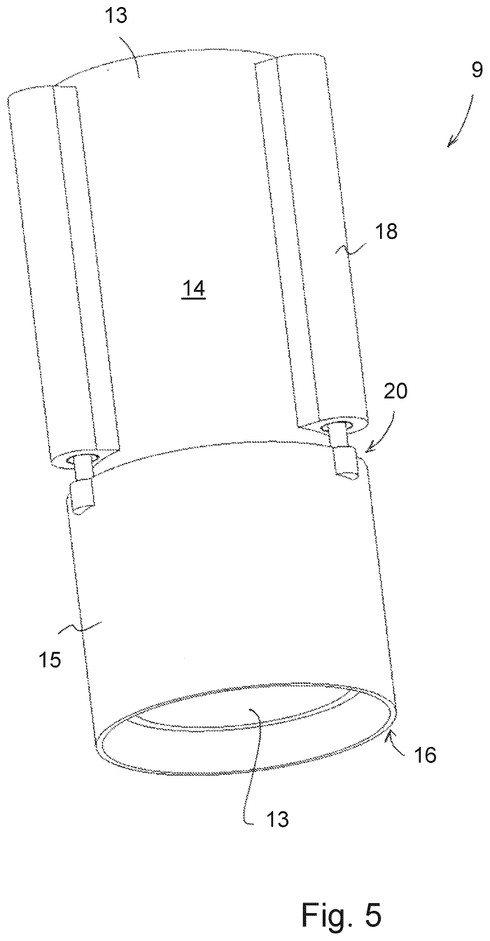

A third embodiment similar to the first embodiment of the hold-down tool 9 shown in FIG. 5 provides a contact ring as a contact element 15. The contact ring 15 provides the annular tool contact surface 16. It can be swivelled at three points and is supported in a flexible manner on the hollow body 13 of the hold-down tool 9. The bearing is provided by springs 17 guided in guides 18 and three heads 20, which may be designed as ball heads, for example.

The contact ring 15 of the hold-down tool 9 is placed with the tool contact surface 16 against the upper, first contact component 1. It can be tilted against the hollow body 13 of the hold-down tool 9. Due to its closed lateral surface, it also serves as an extended splash guard.

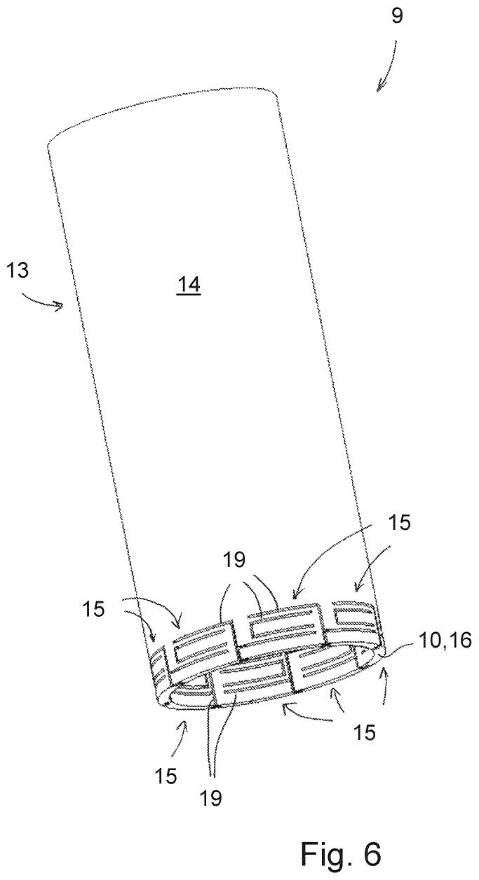

FIG. 6 shows a fourth embodiment of the hold-down tool 9. The hollow body 13 provides eight contact elements 15 distributed in the circumferential direction adjacent to its first end face 10. The contact elements 15 each have slit-like recesses 19, which are meander-shaped and provide flexibility due to the meander shape. The flexibility can be established, for example, via upper joints, especially solid-state hinges.

The contact elements 15 are realized in the fourth embodiment of the hold-down tool 9 as part of the hollow body 13. Together, the contact elements 15 form a flexible ring, which enables the hold-down tool 9 to be placed flat against the upper, first contact component 1 with the tool contact surface 16 formed by its first end face 10.

The meandering, slit-like recesses 19 can be produced by eroding, for example.

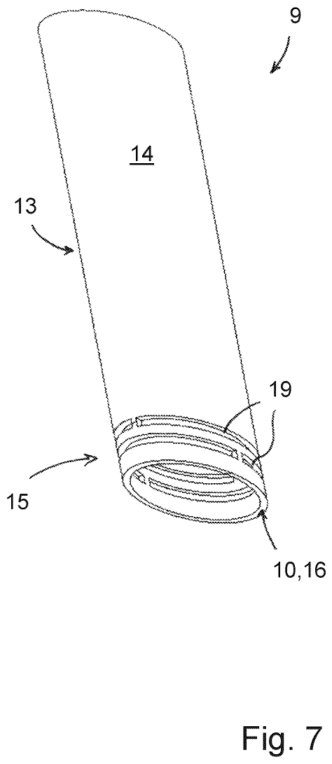

A fifth embodiment of the hold-down tool 9, similar to the fourth embodiment, is shown in FIG. 7. Here, the slit-like recesses 19 form the contact element 15, which is part of the hollow body 13. The contact element 15 is implemented in the manner of a cardan joint, which makes it possible to place the hold-down tool 9 with the first end face 10 of the hollow body 13, which also serves as the tool contact surface 16, against the upper, first contact component 1.

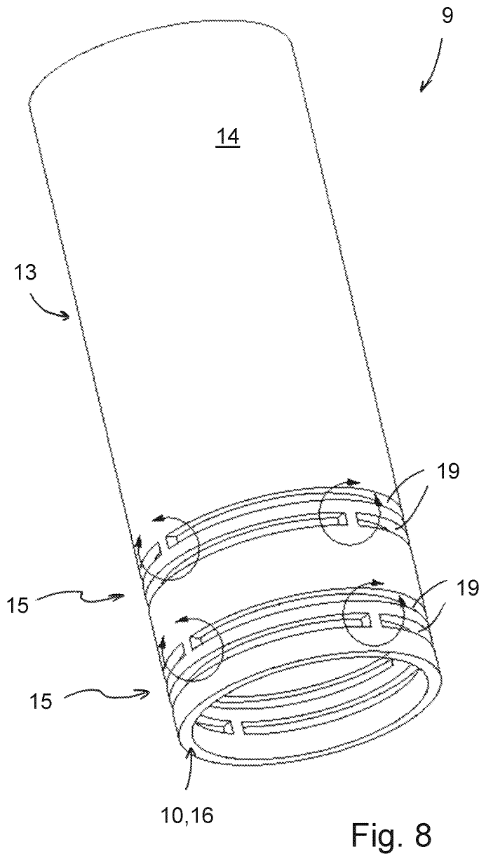

FIG. 8 shows a sixth embodiment of the hold-down tool 9, in which two groups of slit-like recesses 19, which are arranged on top of each other and adjacent to each other with respect to the symmetry axis 8 of the hold-down tool 9, form two contact elements 15 in the form of a double cardan joint. The contact elements 15 are also realized here as part of the hollow body 13.

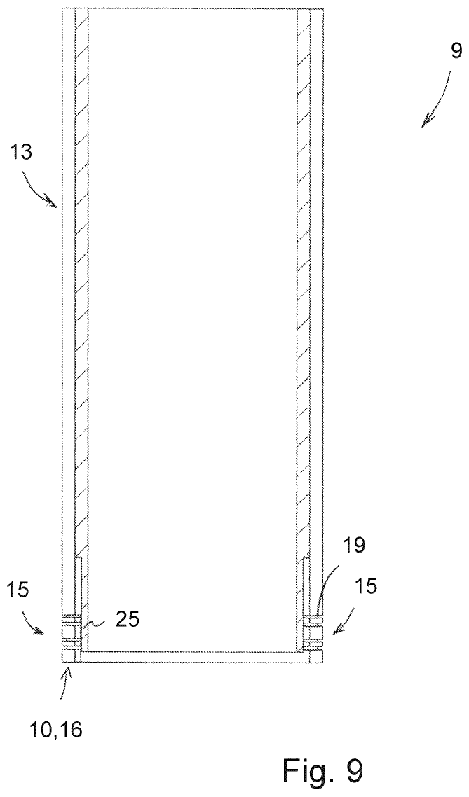

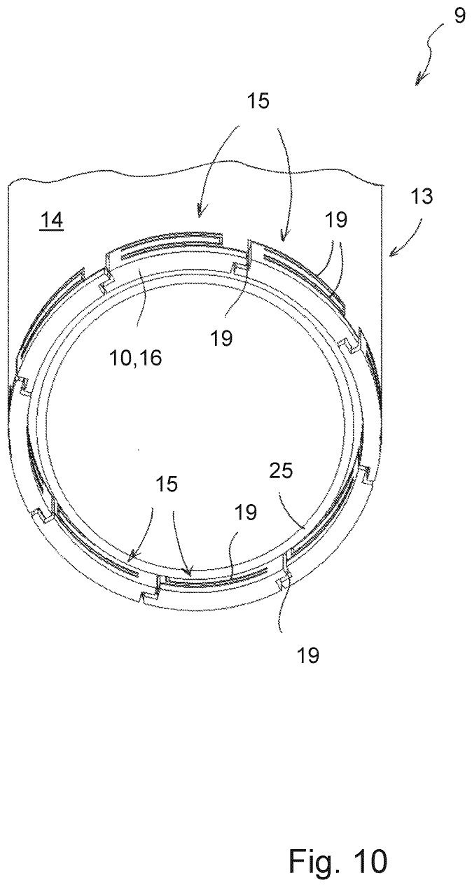

FIGS. 9 and 10 show a seventh embodiment of the hold-down tool 9. The seventh embodiment of the hold-down tool 9 is a further development of the sixth embodiment of the hold-down tool 9 according to FIG. 6. The hold-down tool 9 has a splash guard 25, which protrudes from the inside beyond the slit-like recesses 19 and is radially spaced from them.

The splash guard 25 prevents splashes from leaking through the recesses 19 or solidifying in the recesses 19 and then impairing flexibility or elasticity.

The splash guard 25 ends above the tool contact surface 16 in such a way that it is also provided at a distance from the upper, first contact component 1 if the hold-down device 9 is placed on the upper, first contact component 1. The radial distance of the splash guard 25 to the contact elements 15 formed by the slit-like recesses 19 ensures elasticity or flexibility when the hold-down device 9 is placed.

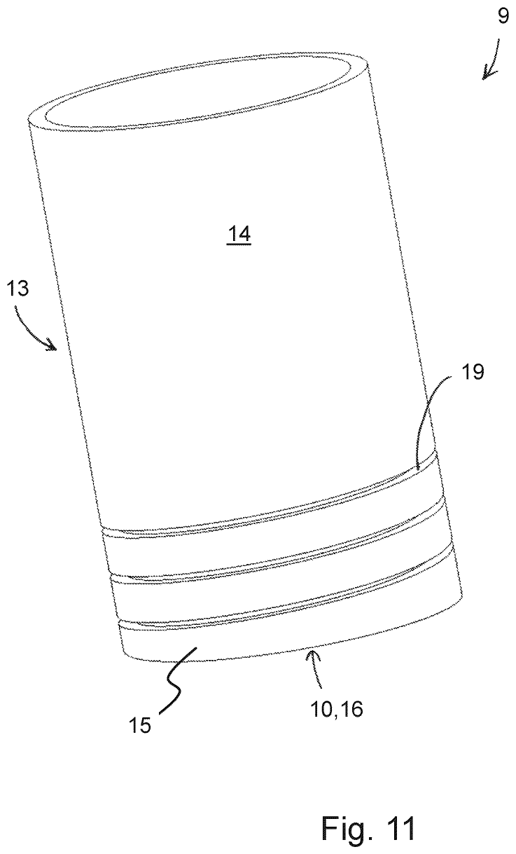

An eighth embodiment of the invention according to FIG. 11 provides a hold-down tool 9, in which the hollow body 13 with the end face 10 forms the tool contact surface 16 and, adjacent to the tool contact surface 16, provides a helical or helix-shaped, slit-like recess 19. The recess 19 provides a flexibility by means of which the contact element 15 is defined, which is also realized here as part of the hollow body 13.

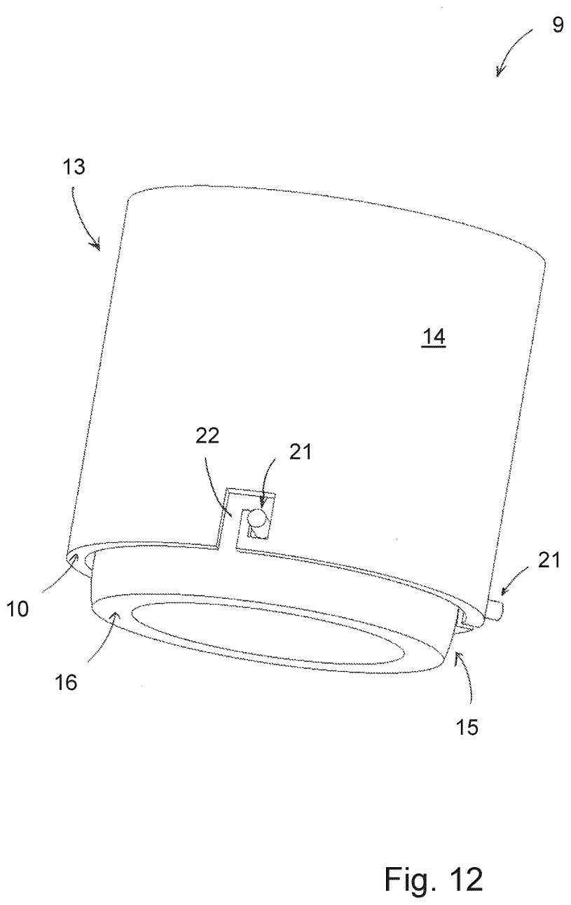

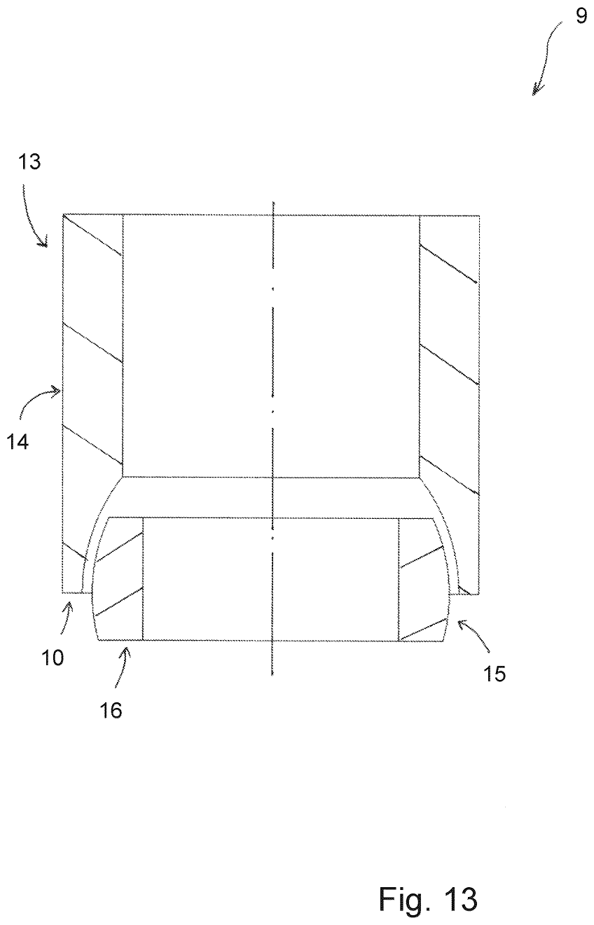

A ninth embodiment of the hold-down tool 9 according to FIGS. 12 and 13 provides a contact element 15 formed separately from the hollow body 13. The contact element 15 can be swivelled relative to the hollow body 13. It provides a ball ring-segment-like outer lateral surface that engages in a ball-bearing-shaped receptacle of the hollow body 13. The ball ring-segment-like contact element 15 also provides a passage recess through which the focused laser beam 7, which is not shown in FIGS. 12 and 13, can pass through.

In addition to the swivelling connection of the hollow body 13 and the contact element 15, the contact element 15 provides pins 21 protruding from its outer lateral surface, which engage in a labyrinth-like guide groove 22 formed on the hollow body 13 and providing a degree of freedom of movement extended in the direction of the axis of symmetry 8 of the hollow body 13. The shape of the guide groove 22 also means that the contact element 15 can be changed quickly and easily by means of a combined longitudinal and rotary movement.

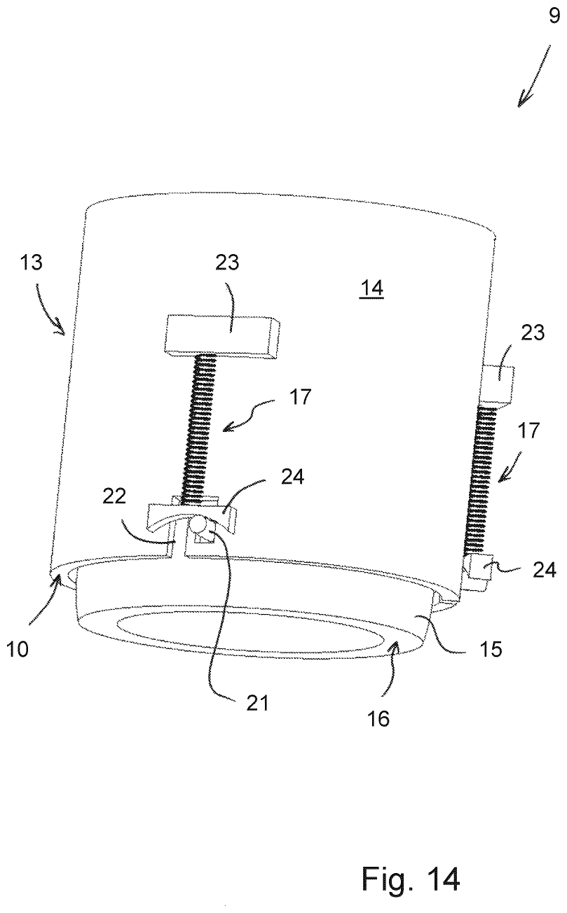

A tenth embodiment of the hold-down tool 9 according to FIG. 14, similar to the ninth embodiment, provides, in addition to the pins 21 and the guide groove 22, springs 17 which are held on the hollow body 13 by means of a first holder 23 and against the pins 21 by means of a second holder. The springs 17 extend in the direction of the longitudinal center axis or axis of symmetry 8 of the hollow body 13 and thus define elasticity or flexibility of the hold-down tool 9 in the direction of the longitudinal center axis or axis of symmetry.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A hold-down tool for a laser welding system, the hold-down tool comprising:
a tubular hollow body that has a lateral surface that is designed to be closed in a laminar manner at least in some sections; and
at least one contact element that is designed to be flexible and/or is held in a flexible manner and provides a tool contact surface for bringing the contact element into contact with a contact component to be welded.

2. The hold-down tool according to claim 1, wherein at least three and preferably at least five and particularly preferably seven or more contact elements are provided.

3. The hold-down tool according to claim 1, wherein the contact elements are spaced from each other in a circumferential direction of the hollow body and can be arranged evenly distributed.

4. The hold-down tool according to claim 1, wherein the contact element is part of the hollow body.

5. The hold-down tool according to claim 1, wherein the tool contact surface is an end face of the hollow body.

6. The hold-down tool according to claim 1, wherein the at least one contact element is attached to the hollow body on an outer shell side.

7. The hold-down tool according to claim 1, wherein the at least one contact element is spring-mounted and/or substantially perpendicular to the hollow body and/or held on the hollow body.

8. The hold-down tool according to claim 1, wherein the tool contact surface is convex.

9. The hold-down tool according to claim 1, wherein the tool contact surface is ring-shaped and/or flat.

10. The hold-down tool according to claim 1, wherein the hollow body provides slot-like recesses for the ensuring flexibility and/or flexible support of the at least one contact element, and wherein the slit-like recesses are meandering and/or helix-shaped.

11. The hold-down tool according to claim 1, wherein the at least one contact element is a contact pin and/or as a contact ring and/or as a hollow ball ring segment and/or that the at least one contact element provides an outer later surface shaped like a ball ring segment.

12. The hold-down tool according to claim 11, wherein the contact element engages in the ball ring-segment-like outer lateral surface in a ball bearing-shaped receptacle of the hollow body.

13. The hold-down tool according to claim 1, wherein the hollow body has a symmetry axis and/or wherein the flexibility and/or flexible support of the at least one contact element acts in a direction of the axis of symmetry.

14. The hold-down tool according to claim 1, wherein the contact element and/or the hollow body is made of an electrically insulating material or of technical ceramics in an area comprising the tool contact surface.

15. A laser welding system comprising:
a laser source;
an optical unit for shaping a laser beam provided by the laser source and for providing a focused laser beam; and
the hold-down tool according to claim 1,
wherein the focused laser beam is guided through the hollow body of the hold-down tool.
